(19) United States
(12) Patent Application Publication
(10) Pub. No.: US 2023/0019766 A1
(43) Pub. Date: Jan. 19, 2023

(54) SELF-CHARGING INVERTER

(71) Applicants: Winfree Mhere, Pendleton, OR (US); Stephen Machado, Pendleton, OR (US); Leeroy Kunzwa, Pendleton, OR (US)

(72) Inventors: Winfree Mhere, Pendleton, OR (US); Stephen Machado, Pendleton, OR (US); Leeroy Kunzwa, Pendleton, OR (US)

(21) Appl. No.: 17/863,692

(22) Filed: Jul. 13, 2022

Related U.S. Application Data
(60) Provisional application No. 63/221,241, filed on Jul. 13, 2021.

(51) Int. Cl. H02J 9/06

(52) U.S. Cl. CPC H02J 9/061; H02J 9/068

(57) ABSTRACT

A method and apparatus for supplying clean and economical electricity. The apparatus includes a self-charging inverter and a changeover system. The self-charging inverter can be connected to two batteries in which one battery can provide electricity while another battery is charged simultaneously. The changeover system can switch the power supply from an exhausted battery to a charged battery without interrupting the power supply. The changeover system is automated by including a voltage sensor to detect the charge level of the two batteries.

### CROSS-REFERENCE TO RELATED APPLICATIONS

This application claims priority from a U.S. Provisional Patent Appl. No. 63/221,241 filed on Jul. 13, 2021, which is incorporated herein by reference in its entirety.

### FIELD OF INVENTION

The present invention relates to a self-charging inverter, and more particularly, the present invention relates to a self-charging inverter that produces clean and economical energy.

### BACKGROUND

Electricity is an essential part of the modern world and almost every task requires electricity for operation. Electricity has become the soul of the modern world and is essential for industrial growth. However, the majority of the electricity is produced from fossil fuels. The problem with fossil fuels is their limited reserves and the pollution caused by burning fossil fuels. The cost of fossil fuels is also rising continuously and so is the cost of electricity.

Thus, considering the importance of electricity in day-to-day life and in industries, a need is appreciated for a clean and abundant source of electricity.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an apparatus that can produce clean and unlimited energy.

It is another object of the present invention that apparatus can be operated economically.

It is another object of the present invention that the apparatus allows switching from an exhausted battery to a charged battery without interruption in the electricity supply.

It is still another object of the present invention that the apparatus can automatically detect battery charge levels and act accordingly.

In one aspect, disclosed is an apparatus that includes a self-charging inverter and a changeover system. The self-charging inverter can be connected to two batteries in which one battery can provide electricity while another battery is charged. The changeover system can switch the power supply from an exhausted battery to a charged battery without interrupting the power supply. The changeover system can be automated by including a voltage sensor wherein the voltage sensor can detect the charge level of the batteries. The changeover system can detect the voltages of the two batteries and switch to the charged one for the power supply. The from the charged battery can be drawn by the inverter, the inverter can include a step-up DC to AC transformer for conversion and stepping up the voltage.

In one aspect, disclosed is an apparatus for supplying clean energy, the apparatus comprises an inverter unit and a changeover system. The inverter unit includes a charging port for charging a battery; a power port for receiving power from a battery; a main-supply port for connecting to a main power supply; and one or more output ports for connecting to one or more loads. The inverter unit includes a plurality of relay modules configured for interchangeably coupling a first battery and a second battery to the charging port and the power port; a plurality of sensors configured to determine a charge status of the first battery and the second battery; and a control unit operably coupled to the plurality of relay modules and the plurality of sensors, wherein the control unit is configured to automatically switch the first battery and the second battery between charging port and the power port based on the charge status of the first battery and the second battery, wherein the first battery or the second battery that is having the charge status above the predetermined threshold value is connected to the power port and the another battery is connected to the charging port.

In one implementation, the charging port is operably coupled to the power port and the main-supply port, wherein the control unit is configured to supply electricity to the charging port from either the power port or the main-supply port. Preferably, the charging port is powered by the power port. The control unit is configured to switch the first battery and the second battery without noticeable interruption of power supply to the one or more output ports from the power port. The power port is configured to power the one or more output ports and the charging port, wherein a distribution of the power between the one or more output ports and the charging port is controlled by the control unit. The plurality of sensors are configured to detect voltage, wherein the charge status is determined from voltage readings by the plurality of sensors. The first battery and the second battery are 12 V batteries, and the predetermined threshold value is 11 V. The inverter unit further comprises one or more transformers for voltage step-up, and dc to ac conversion. The method further includes the steps of

In one aspect, disclosed is a method for supplying clean energy, the method comprising the steps of providing an apparatus. The apparatus comprises inverter unit and a changeover system. The inverter unit includes a charging port for charging a battery; a power port for receiving power from a battery; a main-supply port for connecting to a main power supply; and one or more output ports for connecting to one or more loads. The inverter unit includes a plurality of relay modules configured for interchangeably coupling a first battery and a second battery to the charging port and the power port; a plurality of sensors configured to determine a charge status of the first battery and the second battery; and a control unit operably coupled to the plurality of relay modules and the plurality of sensors, wherein the control unit is configured to automatically switch the first battery and the second battery between charging port and the power port based on the charge status of the first battery and the second battery, wherein the first battery or the second battery that is having the charge status above the predetermined threshold value is connected to the power port and the another battery is connected to the charging port. The method further includes the steps of connecting the first battery to the power port and the second battery to the charging port; receiving energy from the first battery, wherein a portion of the energy is supplied to the charging port for charging the second battery simultaneously; and checking, at predetermined intervals, the charge status of the first battery and the second battery; switching, automatically, the first battery and second battery when the first battery is discharged, or the second battery is charged. The method further comprises the steps of upon switching, checking, at the predetermined intervals, the charge status of the first battery and the second battery; and upon switching, again switching the second battery and the first battery, when the second battery is discharged, and the first battery is charged.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram of a changeover system, according to an exemplary embodiment of the present invention.

FIG. 2 is a flowchart of the changeover system, according to an exemplary embodiment of the present invention.

FIG. 3 is a block diagram of the self-charging inverter, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation. Moreover, the drawings may not be to scale.

Disclosed is an apparatus for generating clean and continuous energy without consuming any fossil fuels or using any renewable energy. Only the external power is needed to charge at least one battery and to start the disclosed apparatus. Once started, the disclosed apparatus can continue producing electricity without any input from the external power supply. Alternatively, a small share of the external power supply can be used.

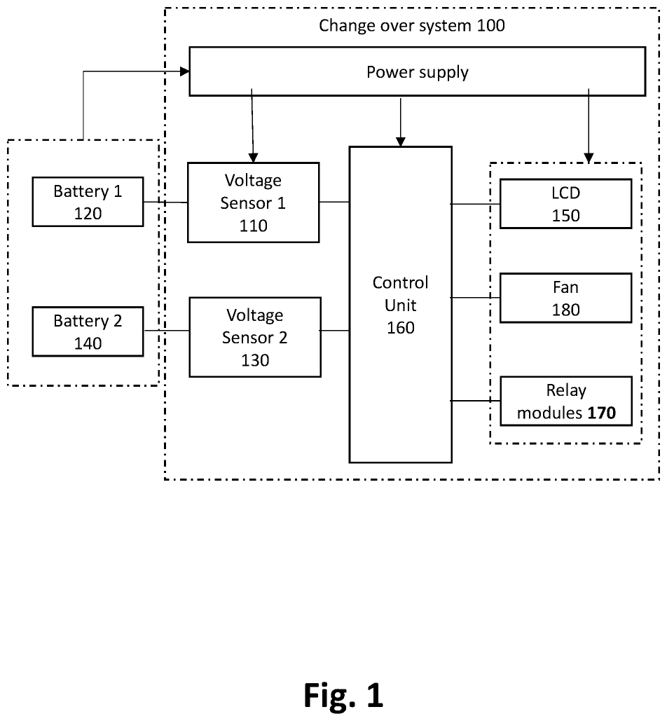

Referring to FIG. 1 is a block diagram of the changeover system 100 of the disclosed apparatus. The changeover system 100 can include a first voltage sensor 110 that can connect to a first battery 120 and a second voltage sensor 130 that can connect to a second battery 140 of the disclosed apparatus. The changeover system can also include a display 150 that can display voltage readings, the status of the disclosed apparatus, alerts and errors, and the like details of the disclosed apparatus. The changeover system can also include an input panel to receive any input, such as the settings and the like. The input panel can be provided as push buttons and can also include start and stop buttons. In one implementation, the display can be in the form of a touch panel that can receive input from the user. The user herein refers to any person using or willing to use the disclosed apparatus or any person who operates or intends to operate the disclosed apparatus. The display can be provided as an LCD screen. The changeover system can also include a control unit 160, such as a microcontroller that can control the operation of the disclosed changeover system. The control unit can be operably connected with the two voltage sensors to receive the measured voltage readings. The control unit can also be connected to the display to show the information. The control unit, through suitable relay module 170 can also selectively connect the two batteries to the self-charging inverter of the disclosed apparatus. A fan 180 can also be provided for removing the heat generated by the changeover system 100. A power supply of the inverter is also shown that powers the disclosed changeover system 100.

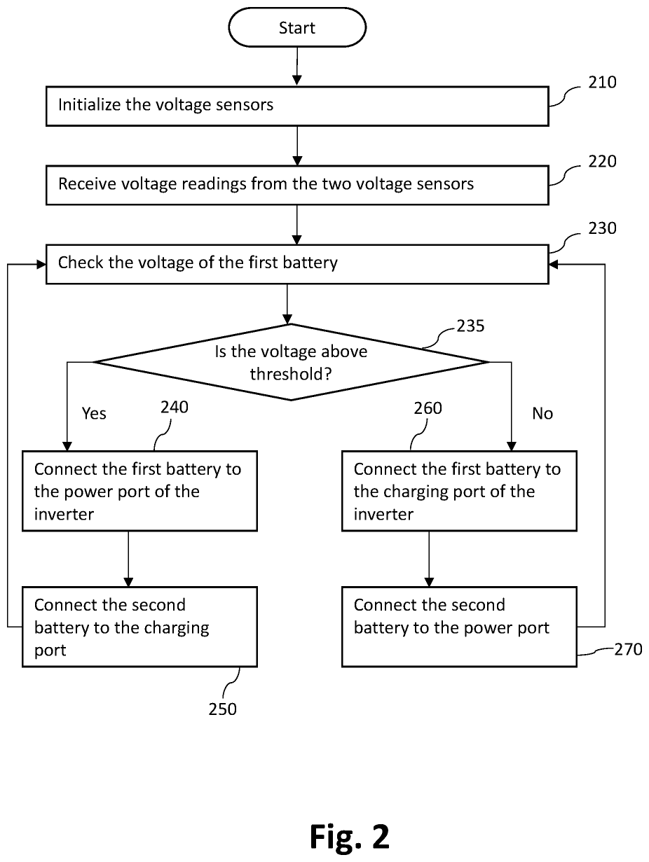

Referring to FIG. 2, a flowchart is shown to illustrate the exemplary embodiment of working of the changeover system. First, the changeover system can power up, at step, an external power supply may be needed to start the disclosed apparatus. The different sensors can be initialized at step 210. The control unit can receive voltage readings from the two voltage sensors, at step 220. At first, the control unit can check the voltage of the first battery at step 230. A check can be made at step 235 if the voltage of the first battery is above the predetermined threshold, the control unit can connect the first battery to the power port of the inverter, at step 240. The power port is configured to draw energy from the battery for powering one or more appliances conned to the inverter. Upon connecting the first battery to the power port, the control unit can connect the second battery to the charging port, at step 250. However, if the voltage of the first battery is below the threshold voltage, such as the 11V threshold limit for a 12V battery, the control unit can connect the first battery to the charging port of the inverter at step 260 and the second battery to the power port. The charging port can charge the first battery, and the charging port can be powered by the main power supply and/or the power port of the inverter that is connected to one of the two batteries which is not being charged. In both cases, the control unit can continue checking the battery voltage or charge status and take appropriate steps if any changes are detected. When the first battery is connected to the charging port, the control unit can check the voltage of the second battery, and if the voltage of the second battery is above the threshold voltage value, the second battery can be connected to the power port of the inverter for power supply. However, if the second battery is also not charged, the second battery can also be connected to the charging port of the inverter. The control unit can continue monitoring the voltages of the two batteries at predefined intervals, and automatically connect the charged battery to the power port of the inverter and the discharged or exhausted battery to the charging port of the inverter. The control unit can use suitable relay modules to switch a battery between the two ports of the inverter. The control unit can also turn the external power supply on and off as and when required. Suitable overcharge protection circuitry can also be provided to prevent overcharging of the batteries.

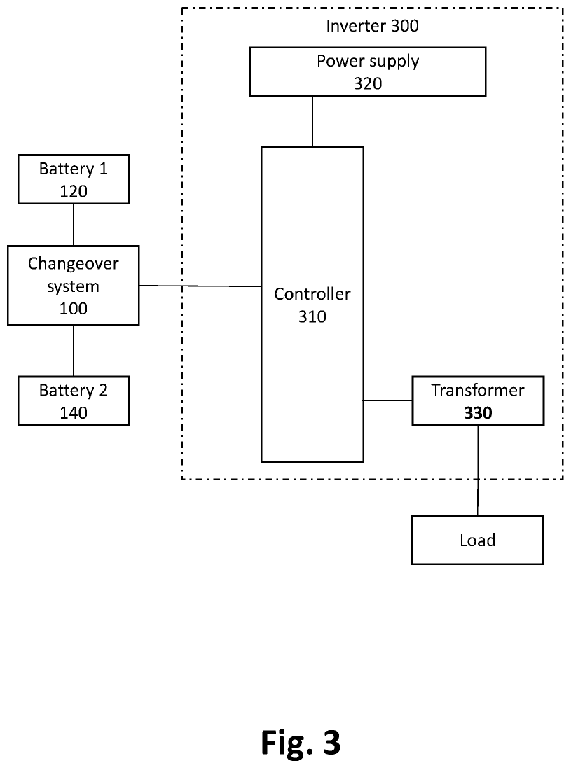

Turning to FIG. 3 which is a block diagram of the self-charging inverter 300 showing an exemplary implementation. The inverter can include another microcontroller 310 that can receive input from the changeover system 100 i.e., the control unit 160 of the changeover system. A power supply 320 can include the charging port, power port, and main power supply port. The inverter can further include one or more transformers 330 for voltage step-up and dc to ac conversion. The inverter can also include the charging circuitry of the battery. The inverter while powered by one of the batteries can divert a small portion of the energy to another battery for charging another battery. When the battery supplying power gets exhausted, the two batteries can be swapped, and the one previously getting charged now starts supplying the power. Depending upon the capacity of the inverter suitable number of loads can be connected to the inverter.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. An apparatus for supplying clean energy, the apparatus comprises:
an inverter unit comprising:
a charging port for charging a battery;
a power port for receiving power from a battery;
a main-supply port for connecting to a main power supply; and
one or more output ports for connecting to one or more loads; and
a changeover system comprising:
a plurality of relay modules configured for interchangeably coupling a first battery and a second battery to the charging port and the power port;
a plurality of sensors configured to determine a charge status of the first battery and the second battery; and
a control unit operably coupled to the plurality of relay modules and the plurality of sensors, wherein the control unit is configured to automatically switch the first battery and the second battery between charging port and the power port based on the charge status of the first battery and the second battery, wherein the first battery or the second battery that is having the charge status above a predetermined threshold value is connected to the power port and the another battery is connected to the charging port.

2. The apparatus according to claim 1, wherein the charging port is operably coupled to the power port and the main-supply port, wherein the control unit is configured to supply electricity to the charging port from either the power port or the main-supply port.

3. The apparatus according to claim 2, wherein the charging port is powered by the power port.

4. The apparatus according to claim 1, wherein the control unit is configured to switch the first battery and the second battery without noticeable interruption of power supply to the one or more output ports from the power port.

5. The apparatus according to claim 1, wherein the power port is configured to power the one or more output ports and the charging port, wherein a distribution of the power between the one or more output ports and the charging port is controlled by the control unit.

6. The apparatus according to claim 1, wherein the plurality of sensors are configured to detect voltage, wherein the charge status is determined from voltage readings by the plurality of sensors.

7. The apparatus according to claim 6, wherein the first battery and the second battery are 12 V batteries, and the predetermined threshold value is 11 V.

8. The apparatus according to claim 1, wherein the inverter unit further comprises one or more transformers for voltage step-up, and dc to ac conversion.

9. A method for supplying clean energy, the method comprising the steps of:
providing an apparatus, the apparatus comprises:
an inverter unit comprising:
a charging port for charging a battery,
a power port for receiving power from a battery,
a main-supply port for connecting to a main power supply, and
one or more output ports for connecting to one or more loads, and
a changeover system comprising:
a plurality of relay modules configured for interchangeably coupling a first battery and a second battery to the charging port and the power port,
a plurality of sensors configured to determine a charge status of the first battery and the second battery, and
a control unit operably coupled to the plurality of relay modules and the plurality of sensors, wherein the control unit is configured to automatically switch the first battery and the second battery between charging port and the power port based on the charge status of the first battery and the second battery, wherein the first battery or the second battery that is having the charge status above a predetermined threshold value is connected to the power port and the another battery is connected to the charging port;
connecting the first battery to the power port and the second battery to the charging port;
receiving energy from the first battery, wherein a portion of the energy is supplied to the charging port for charging the second battery simultaneously; and
checking, at predetermined intervals, the charge status of the first battery and the second battery;
switching, automatically, the first battery and second battery when the first battery is discharged, or the second battery is charged.

10. The method according to claim 9, wherein the method further comprises the steps of:
upon switching, checking, at the predetermined intervals, the charge status of the first battery and the second battery; and
upon switching, again switching the second battery and the first battery, when the second battery is discharged, and the first battery is charged.

11. The method according to claim 9, wherein the charging port is operably coupled to the power port and the main-supply port, wherein the control unit is configured to supply electricity to the charging port from either the power port or the main-supply port.

12. The method according to claim 11, wherein the charging port is powered by the power port.

13. The method according to claim 9, wherein the control unit is configured to switch the first battery and the second battery without noticeable interruption of power supply to the one or more output ports from the power port.

14. The method according to claim 9, wherein the power port is configured to power the one or more output ports and the charging port, wherein a distribution of the power between the one or more output ports and the charging port is controlled by the control unit.

15. The method according to claim 9, wherein the plurality of sensors are configured to detect voltage, wherein the charge status is determined from voltage readings by the plurality of sensors.

16. The method according to claim 15, wherein the first battery and the second battery are 12 V batteries, and the predetermined threshold value is 11 V.

17. The method according to claim 9, wherein the inverter unit further comprises one or more transformers for voltage step-up, and dc to ac conversion.
